(19) United States
(12) Patent Application Publication
(10) Pub. No.: US 2025/0030280 A1
(43) Pub. Date: Jan. 23, 2025

(54) STATOR, AND ELECTRIC MOTOR HAVING SUCH A STATOR

(71) Applicant: Brose Fahrzeugteile SE & Co. Kommanditgesellschaft, Würzburg, Würzburg (DE)

(72) Inventors: Marco GRIMM, Unterschleissheim (DE); Stefan WÜST, Lohr am Main (DE)

(21) Appl. No.: 18/907,808

(22) Filed: Oct. 7, 2024

Related U.S. Application Data
(63) Continuation of application No. PCT/EP2023/058760, filed on Apr. 4, 2023.

(30) Foreign Application Priority Data
Apr. 6, 2022 (DE) 10 2022 203 436.8

(51) Int. Cl. H02K 1/16

(52) U.S. Cl. CPC H02K 1/165

(57) ABSTRACT

A stator of an electric motor includes a tooth and a coil body. The tooth can be radially divided, from a central axis of the stator, into consecutive portions being a tooth root, a tooth neck and a tooth head. The tangential dimensions of the tooth root and tooth head project beyond those of the tooth neck. The coil body is U-shaped and, after attachment to the tooth, at least partially axially and radially covers the portions. The coil body can be force-lockingly secured to the tooth, between the tooth root and the tooth head, in a radial direction relative to the central axis. An electric motor having the stator is also provided.

### CROSS-REFERENCE TO RELATED APPLICATION

This application is a continuation, under 35 U.S.C. § 120, of copending International Patent Application PCT/EP2023/058760, filed Apr. 4, 2023, which designated the United States; this application also claims the priority, under 35 U.S.C. § 119, of German Patent Application DE 10 2022 203 436.8, filed Apr. 6, 2022; the prior applications are herewith incorporated by reference in their entirety.

### FIELD AND BACKGROUND OF THE INVENTION

The present invention relates to a stator for an electric motor, having a tooth and a coil body, wherein the tooth can be radially divided, from a central axis of the stator, into successive portions being a tooth root, a tooth neck and a tooth head, tangential dimensions of the tooth root and the tooth head project beyond those of the tooth neck, and the coil body is U-shaped and, after attachment to the tooth, at least partially axially and radially covers the portions. The invention also relates to an electric motor having such a stator.

The stator is associated with an electric motor and cooperates with a rotor. The stator generally serves to generate an electromagnetic field which causes the rotor to rotate.

In order to generate the electromagnetic field described above, the stator is equipped with a number of stator windings disposed on teeth of the stator. The stator usually includes axially layered sheet metal laminations and serves, on the one hand, to transmit the magnetic flux generated by the winding, and, on the other hand, to mechanically receive the winding. In order to form the stator, the teeth can have a cohesive or isolated construction, the central axis of the stator being coincident with the axis of rotation of the rotor for functional reasons.

An individual tooth can be radially divided, from the central axis of the stator, into successive portions, namely a tooth root, a tooth neck and a tooth head, wherein the tangential dimensions of the tooth root and the tooth head project beyond those of the tooth neck. In order to form an annular stator, the teeth are lined up in series on lateral flanks of the tooth head.

The winding is preferably formed by using an enamel-insulated copper wire which is looped around the tooth, in particular the tooth neck, in a winding machine. In order for the winding to not be damaged by the sheet metal laminations which are punched with sharp edges due to the production process, it is already known for two plastic injection-molded coil bodies which cover the tooth neck and at least partially cover the tooth root and the tooth head to be attached before the winding process on the tooth. The generally U-shaped coil bodies are placed axially over both end sides of the tooth in order to protect that part of the tooth which could theoretically come into contact with the winding.

In order for the coil bodies to not loosen again after their attachment to the tooth, which can occur for example when the coil body is being clamped into the winding machine, the coil bodies are force-lockingly fixed to the tooth in a tangential direction in a known manner. To that end, the two limbs of the U-shaped coil body, which extend along the tooth neck, are provided with an oversize in relation to the tangential width of the tooth neck. That oversize is the result of reduction or tapering of the clear width between the limbs from the end side of the tooth along the tooth neck. The oversize is produced in that case either by deliberate use of production-related shrinkage, which automatically occurs during the cooling of the coil body after the injection molding process, or the oversize is retained from the outset in the plastics injection molding tool. The tooth is fitted with such coil bodies by using a spreading tool which moves the limbs far apart from one another in such a way that the coil body can be positioned on the tooth. After that mounting step, the limbs, due to the resilient property of the plastic, exert a clamping force on the tooth neck, the clamping force force-lockingly holding the coil body on the tooth.

It has been shown to be disadvantageous in the aforementioned concept that the clamping force decreases as the axial length of the stator increases. That is because the clear width between the limbs cannot be reduced as required since otherwise plastic deformation or even breakage of the coil body occurs.

### SUMMARY OF THE INVENTION

It is accordingly an object of the invention to provide an improved stator and an electric motor having such a stator, which overcome the hereinafore-mentioned disadvantages of the heretofore-known stators and motors of this general type and which enable reliable force-locking fixation of a coil body to a stator tooth.

With the foregoing and other objects in view there is provided, in accordance with the invention, a stator of an electric motor, comprising teeth which are radially divided, from a central axis of the stator, into successive portions, namely a tooth root, a tooth neck and a tooth head. The tangential dimensions of the tooth root and the tooth head are dimensioned in such a way that they project beyond those of the tooth neck.

Furthermore, a coil body composed of an insulating material such as plastic is provided, the coil body being U-shaped and, after its attachment to the tooth, at least partially axially and radially covering the aforementioned portions. In the region of the tooth neck, the coil body is preferably provided with channels in which the coil wire is form-lockingly guided. The coil body is force-lockingly fixed to the tooth, in a radial direction with respect to the central axis, between the tooth root and the tooth head. Before attachment to the tooth, the coil body has an oversize with respect to a radial distance between the tooth root and the tooth head. In the context of the attachment to the tooth, the coil body is compressed with respect to its radial dimension, resulting in the force-locking engagement.

With the objects of the invention in view, there is also provided an electric motor comprising such a stator.

The dependent claims provide advantageous developments and embodiments.

In a preferred embodiment, the coil body is equipped on the tooth head side with at least one winding shield which tangentially bears at least against one of two sides of the tooth head that face toward the central axis and ensures the force-locking fixation in the radial direction. The sides of the tooth run either in a rectilinear or arcuate manner in an angular range of between 75° and 105°, preferably 90°, with respect to a radius proceeding from the central axis of the stator. The winding shield is preferably divided into a first region which is close to the tooth neck and a second region which is remote from the tooth neck. The first region bears weakly against the side of the tooth, and the second region has an oversize in relation to the side of the tooth for the force-locking fixation. This requires that, before attachment of the coil body to the tooth, a spreading tool be used to bring the second region into a position which permits the attachment without any collision with the tooth. For the radial guidance of the winding, in particular of the winding head located on the end side of the tooth, the winding shield projects axially beyond the tooth. Preferably, the winding shield has two regions which are close to the tooth neck and remote from the tooth neck and come into abutment against the two sides of the tooth.

In order to set the force which is intended to prevail after the attachment of the coil body to the tooth, the winding shield is equipped with a predetermined bending point which preferably faces toward the side of the tooth head and is disposed between the first and the second regions. In other words, the force can be set by way of the positioning and the geometrical configuration of the predetermined bending point (depth and shape of an impression).

In order to provide the defined end-side support of the coil body on the tooth, the latter is equipped with a web which runs tangentially on that side of the winding shield which faces away from the central axis. Since the web also extends over the two aforementioned first and second regions of the tooth neck, the web is equipped with a preferably circular cutout in the region of the predetermined bending point. However, other geometries, such as a V shape, are also conceivable.

In order to provide the stiffening of the winding shield, the latter is equipped in the region of the tooth neck with support struts which preferably extend axially from the web in the region of the tooth neck.

In a particular embodiment, only the region which is remote from the tooth neck projects axially beyond the tooth, and, by contrast, the region which is close to the tooth neck has a laying groove at the level of the web for a winding wire, the laying groove extending radially in the direction of the tooth.

Other features which are considered as characteristic for the invention are set forth in the appended claims.

Although the invention is illustrated and described herein as embodied in a stator and an electric motor having such a stator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a stator with wound coil bodies;

FIG. 2 is a top-plan view of a tooth of the stator;

FIG. 3 is a fragmentary, perspective view from the front of a tooth with a coil body;

FIG. 4 is a fragmentary, perspective view from the rear of a tooth with a coil body;

FIG. 5 is a top-plan view of a coil body with and without a tooth; and

FIG. 6 is a detail view of the coil body with and without a tooth.

### DETAILED DESCRIPTION OF THE INVENTION

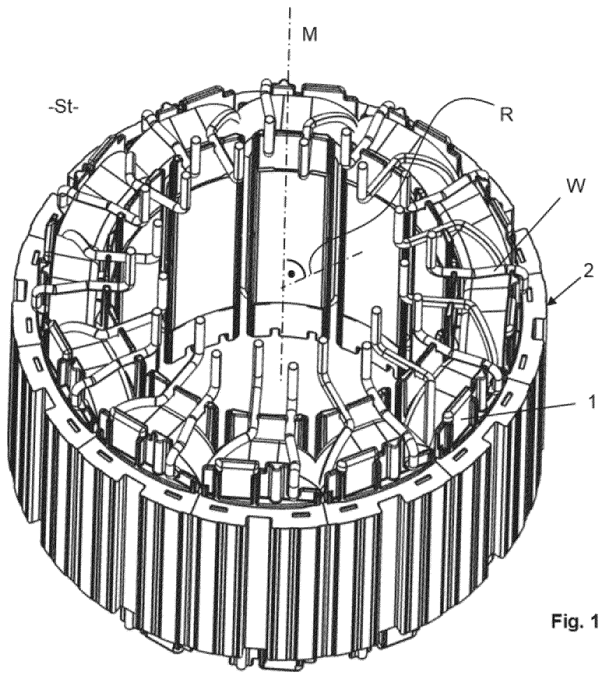

Referring now to the figures of the drawings in detail and first, particularly, to FIG. 1 thereof, there is seen a stator St of a brushless electric motor, the stator being formed from (stator) teeth 2 which are disposed concentrically with respect to a central axis M.

In order to generate an electromagnetic field, the stator St of an electric motor is equipped with a number of (stator) windings W disposed on (individual) teeth 2 of the stator St. A tooth 2 is formed of punch-stacked sheet metal laminations and serves, on the one hand, to transmit the magnetic flux generated by the winding W, and, on the other hand, to mechanically receive the winding W. A coil body 1 composed of plastic with a certain basic elasticity is disposed between the winding W and the tooth 2, the coil body providing protection against the generally sharp-edged sheet metal laminations and thus preventing damage to the winding W in addition to a short circuit.

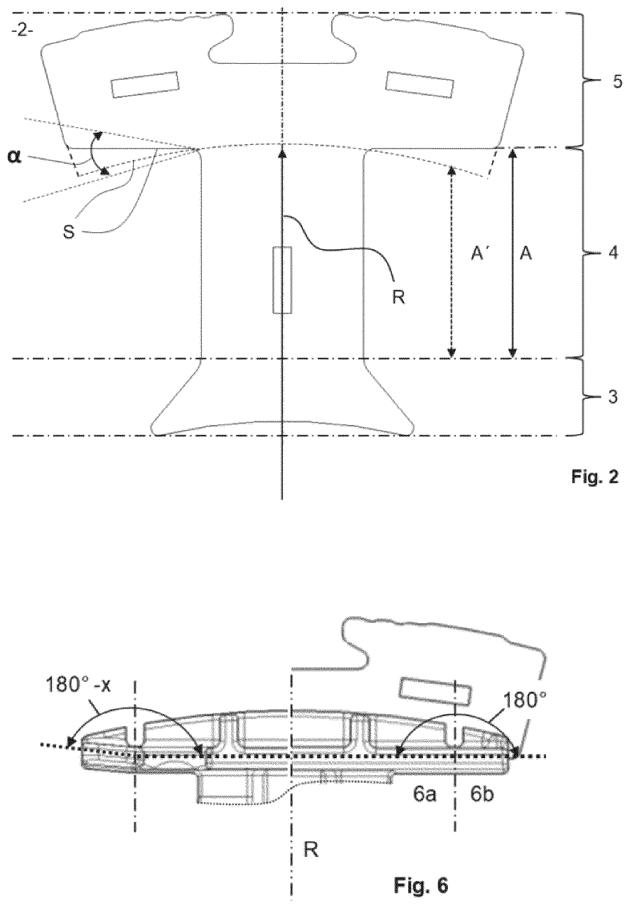

In accordance with FIG. 2, the tooth 2 is radially divided, from the central axis M of the stator St, into successive portions, namely tooth root 3, tooth neck 4 and tooth head 5, wherein the tangential dimensions of the tooth root 3 and the tooth head 5 project beyond those of the tooth neck 4.

On its side facing away from the central axis M, the tooth head 5 has a dovetail-shaped groove for receiving a spring element which ensures acoustic decoupling between the stator St and a housing (not shown). Running tangentially on both sides adjacent to this groove is an electromagnetically optimized contour which runs substantially concentrically with respect to the central axis M. The sides of the tooth head 5 are oriented in the direction of the central axis M, in such a way that lining identical teeth 2 up in series forms a stator ring. The sides S of the tooth head 5 that face toward the central axis M run orthogonally (90°) with respect to the axis of symmetry of the tooth 2, but may also run in an arcuate manner, as shown by the dotted line. The tooth head 5 is adjoined in the direction of the central axis M by the tooth neck 4, the lateral flanks of which extend in parallel over a distance A, A′ as far as the tooth root 3. In the direction of the central axis M, the tooth root 3 assumes a trapezoidal widening, so as to ultimately end in a circular contour on the side facing toward the central axis M.

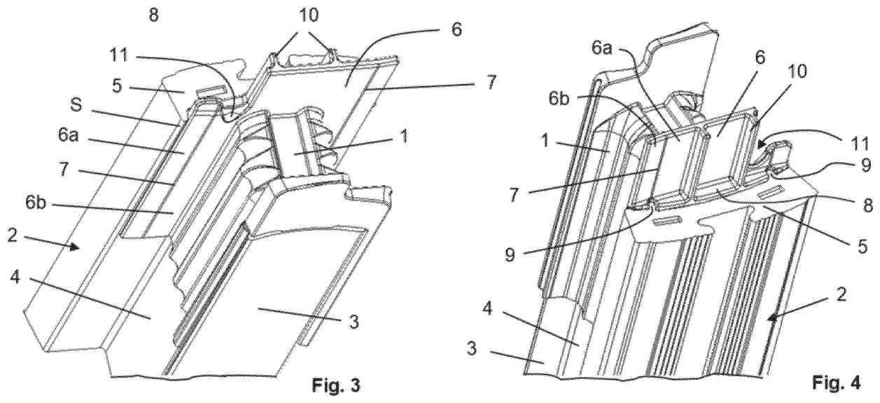

FIGS. 3 and 4 show the tooth 2 with the coil body 1 fixed thereto in a view of the tooth root 3 from the central axis M, and, on the right, of the tooth head 5 from the outside. The coil body 1 is formed from plastic in a U-shaped manner and is fixed to the tooth 2 in such a way that it covers virtually half of the tooth neck 4, the sides S and the trapezoidal widening of the tooth root 3 in the axial direction. In other words, that side of the tooth root 3 which is assigned to the central axis M, the sides of the tooth head 3 and virtually the entire end side of the tooth head 5 are exposed.

In the region of the tooth neck 4, the coil body 1 is equipped with channels which enable targeted deposition of the winding W in the winding process. On the tooth head side, the coil body 1 is integrally equipped with a winding shield 6 which tangentially bears against the sides S of the tooth head 5 that face toward the central axis M and, before attachment to the tooth 2, has an oversize with respect to the radial distance A, A′ between the tooth root 3 and the tooth head 5. In detail, the winding shield 6 has a first region 6a, which is close to the tooth neck and bears weakly against the side S, and a second region 6b, which is remote from the tooth neck and has the oversize in relation to the side S for the force-locking fixation of the coil body 1 in the radial direction. In order to provide a clear functional assignment, a predetermined bending point 7 is impressed between the first region 6a and the second region 6b and faces toward the side S of the tooth head 5.

In addition to the aforementioned regions 6a, 6b, the winding shield 6 projects axially beyond the tooth 2 in the region of the tooth neck 4. As shown in FIG. 4, the coil body 1 is equipped with a web 8 which comes into abutment against the end side of the tooth head 3 and has a circular cutout 9 in the region of the predetermined bending point 7. In order to provide stabilization of the winding shield 6 extending axially beyond the tooth 2, support struts 10 are provided which are disposed at a distance corresponding to the tangential dimension of the tooth neck 4 and extend axially from the web 8.

As is also shown in FIG. 4, the region 6b, which is remote from the tooth neck, projects axially beyond the tooth 2, wherein the region 6a which is close to the tooth neck has a laying groove 11 for a winding wire, the laying groove extending radially in the direction of the tooth 2.

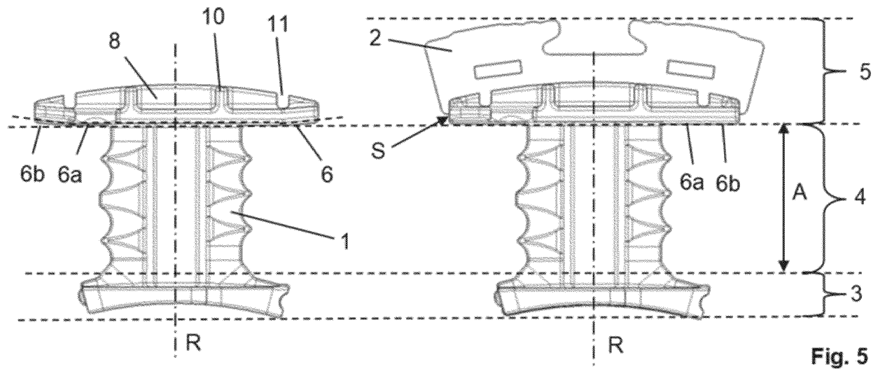

FIG. 5 shows, on the left-hand side, the coil body 1 on its own, and, on the right-hand side, the coil body 1 in a state fixed or mounted on the tooth 2, in each case in a view from above. In this case, in the starting state, that is to say before the fixing to the tooth 2, the regions 6b which are remote from the tooth neck are positioned at an angle in the direction of the tooth head 3 in relation to the sides S of the tooth 2.

In the context of the mounting, a tool (not shown) is positioned on the regions 6b and pushes them along the predetermined bending point 7 into a position in which the coil body 1 can be slid over the tooth 2. As mentioned in the introduction, the coil body 1 is formed of a plastic having a certain basic elasticity. This means in this specific case that after removal of the tool-induced action of force which has resulted in a deflection of the regions 6b which are remote from the tooth neck, these regions wish to assume their original orientation again. A subsequent removal of the tool therefore has the result that the winding shield 6 is force-lockingly fixed to the sides S of the tooth head 5 that face toward the central axis M, between the regions 6b which are remote from the tooth neck and the trapezoidal widening of the tooth root 5.

As can be seen from FIG. 6, the sides S of the tooth 2 run at an angle of 90° with respect to the radius R proceeding from the central axis M. This means that the tooth neck regions 6a, 6b are oriented at an angle of 180° with respect to one another after mounting of the coil body 1 on the tooth 2. In order to produce a force-locking fixation between the region 6b which is remote from the tooth neck and the trapezoidal widening of the tooth root 3, the regions 6b which are remote from the tooth neck are positioned at an angle of less than 180° (180°−x) in the direction of the tooth head 5 in relation to the region 6a which is close to the tooth neck. This angular overlap of the regions 6b which are remote from the tooth neck and the sides S of the tooth 2 forms the above-mentioned oversize.

In summary, the invention relates to a stator St of an electric motor, including a tooth 2 and a coil body 1, wherein the tooth 2 can be radially divided, from a central axis M of the stator St, into successive portions being a tooth root 3, a tooth neck 4 and a tooth head 5, wherein the tangential dimensions of the tooth root 3 and the tooth head 5 project beyond those of the tooth neck 4, wherein the coil body 1 is U-shaped and, after attachment to the tooth 2, at least partially axially and radially covers the portions, and wherein the coil body 1 can be force-lockingly fixed to the tooth 2, in the radial direction with respect to the central axis M, between the tooth root 3 and the tooth head 5.

The claimed invention is not restricted to the exemplary embodiments described above. Rather, other variants of the invention may also be derived from these, within the scope of the recited claims, by a person skilled in the art without departing from the subject matter of the claimed invention. In particular, all individual features described in conjunction with the various exemplary embodiments may furthermore also be combined with one another in other ways, within the scope of the recited claims, without departing from the subject matter of the claimed invention.

The following is a summary list of reference numerals, and the corresponding structure used in the above description of the invention:
1 Coil body
2 Tooth
3 Tooth root
4 Tooth neck
5 Tooth head
6 Winding shield
6a Region which is close to the tooth neck
6b Region which is remote from the tooth neck
7 Predetermined bending point
8 Web
9 Cutout
10 Support strut
11 Laying groove
A,A′ Distance
R Radius
St Stator
W Winding

1. A stator of an electric motor, the stator comprising:
a central axis of the stator;
a tooth configured to be radially divided, from said central axis, into successive portions being a tooth root, a tooth neck and a tooth head;
said tooth root, said tooth neck and said tooth head having tangential dimensions, said tangential dimensions of said tooth root and said tooth head projecting beyond said tangential dimensions of said tooth neck; and
a U-shaped coil body at least partially axially and radially covering said portions, after attachment to said tooth;
said coil body configured to be force-lockingly fixed to said tooth, in a radial direction relative to said central axis, between said tooth root and said tooth head.

2. The stator according to claim 1, wherein:
said tooth root and said tooth head are spaced apart by a radial distance;
said coil body is formed of plastic; and
said coil body, before attachment to said tooth, has an oversize relative to said radial distance.

3. The stator according to claim 2, wherein:
said coil body has a tooth head side;
said tooth head has two sides; and
at least one winding shield is disposed on said tooth head side, said at least one winding shield tangentially bears at least against one of said two sides of said tooth head facing toward said central axis and ensures said force-locking fixation in the radial direction.

4. The stator according to claim 3, wherein:
said side of said tooth runs in a rectilinear or arcuate manner in an angular range of between 75° and 105° relative to a radius proceeding from said central axis; and
said at least one winding shield has a first region disposed closer to said tooth neck and bearing weakly against said side and a second region disposed more remotely from said tooth neck and having an oversize relative to said side for said force-locking fixation.

5. The stator according to claim 4, wherein said at least one winding shield has a predetermined bending point disposed between said first region and said second region.

6. The stator according to claim 5, wherein said predetermined bending point faces toward said side of said tooth head.

7. The stator according to claim 5, wherein said tooth head has an end side, said coil body has a web configured to be brought into abutment against said end side, and said web has a cutout in a region of said predetermined bending point.

8. The stator according to claim 7, wherein said cutout is circular.

9. The stator according to claim 7, wherein said at least one winding shield projects axially beyond said tooth.

10. The stator according to claim 9, wherein said at least one winding shield has support struts in a region of said tooth neck, said support struts extending axially from said web.

11. The stator according to claim 4, wherein said second region disposed more remotely from said tooth neck projects axially beyond said tooth, and said first region disposed closer to said tooth neck has a laying groove for a winding wire, said laying groove extending radially in a direction of said tooth.

12. An electric motor, comprising the stator according to claim 1.
